(19) United States
(12) Patent Application Publication
(10) Pub. No.: US 2013/0067320 A1
(43) Pub. Date: Mar. 14, 2013

(54) Batch Document Formatting and Layout on Display Refresh

(71) Applicant: Microsoft Corporation, Redmond, WA (US)

(72) Inventors: Justin E. Rogers, Redmond, WA (US); Nathan J.E. Furtwangler, Seattle, WA (US); Venkatraman V. Kudallur, Redmond, WA (US); Evgeny N. Veselov, Sammamish, WA (US); Amritam Sarcar, Redmond, WA (US); Christian Stockwell, Redmond, WA (US)

(73) Assignee: Microsoft Corporation, Redmond, WA (US)

(21) Appl. No.: 13/655,379

(22) Filed: Oct. 18, 2012

Related U.S. Application Data
(63) Continuation of application No. 13/229,696, filed on Sep. 10, 2011.

(51) Int. Cl. G06F 17/00

(52) U.S. Cl. 715/234

(57) ABSTRACT

In one or more embodiments, processing efficiencies are gained within the web browser by utilizing the display refresh notifications to drive layout processing within a web browser's layout pipeline. By doing so, the browser can ensure that layout computation is performed when the computed layout is actually to be displayed by the computing device. This can enable the web browser to defer and batch numerous changes into a single layout update, thereby reducing overall CPU utilization while maintaining user responsiveness.

### RELATED APPLICATION

This application is a continuation of and claims priority under 35 U.S.C. §120 to U.S. patent application Ser. No. 13/229,696, filed on Sep. 10, 2011, the disclosure of which is incorporated by reference herein in its entirety.

### BACKGROUND

The web platform that is utilized by a computing device is inherently dynamic. Specifically, in response to user interaction, content downloads, script execution, or other agents, a web browser typically detects change and processes those changes accordingly. In many cases, those changes may result in an update to the visual representation or layout of a particular webpage.

This type of model poses many performance challenges that include, but are not limited to, the need to identify when to process changes. If changes are processed too frequently, work and overhead resources can be wasted. If the changes are processed too infrequently, such may result in poor application responsiveness. Thus, a challenge exists as to how to limit the scope and impact of a particular change within the web platform and, more specifically, the web browser.

### SUMMARY

This Summary is provided to introduce a selection of concepts in a simplified form that are further described below in the Detailed Description. This Summary is not intended to identify key features or essential features of the claimed subject matter.

In one or more embodiments, processing efficiencies are gained within the web browser by utilizing the display refresh notifications to drive layout processing within a web browser's layout pipeline. By doing so, the browser can ensure that layout computation is performed when the computed layout is actually to be displayed by the computing device. This can enable the web browser to defer and batch numerous changes into a single layout update, thereby reducing overall CPU utilization while maintaining user responsiveness.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation in accordance with one or more embodiments.

FIG. 2 is an illustration of a system in an example implementation showing FIG. 1 in greater detail.

FIG. 3 illustrates an example browser in accordance with one or more embodiments.

FIG. 4 is a flow diagram that describes steps in a method in accordance with one or more embodiments.

FIGS. 5 and 6 illustrate an activity diagram in accordance with one or more embodiments.

FIG. 7 illustrates an example computing device that can be utilized to implement various embodiments described herein.

### DETAILED DESCRIPTION

Overview

In one or more embodiments, processing efficiencies are gained within the web browser by utilizing the display refresh notifications to drive layout processing within a web browser's layout pipeline. By doing so, the browser can ensure that layout computation is performed when the computed layout is actually to be displayed by the computing device. This can enable the web browser to defer and batch numerous changes into a single layout update, thereby reducing overall CPU utilization while maintaining user responsiveness.

To appreciate the inventive approaches described below, consider the following example that illustrates some of the processing inefficiencies that can exist in a “layout-driven” approach. A layout-driven approach, in the context of this document, is one that does not necessarily have an appreciation of the refresh frequency of a particular system.

In the past and present, content or style changes can result in a layout update as soon as the browser becomes idle. Independent of these layout updates, display updates can occur on the monitor refresh frequency. These processes are typically independent. Thus, layout processing is typically conducted without an appreciation for the monitor or display refresh frequency. As a result, for each display refresh, numerous layout updates may have been performed. With the exception of the last layout update, all such updates would be wasted and their results ignored. These lost layouts can and often do result in additional CPU utilization, and in some cases can be sufficiently expensive to delay display updates, thereby reducing end user responsiveness.

To help illustrate this situation, consider the following HTML associated with a javascript animation function, animate( ):

```
<!doctype html>
<html>
  <head>
    <script>
      var w = 1;
      function animate( ) {
        document.getElementById(“div”).style.width = (w++)+“px”;
      }
    </script>
  </head>
  <body onload=“setInterval(‘animate( )’, 4)”>
    <div id=“div” style=“width: 0px; height: 100px;
    background: black;”></div>
  </body>
</html>
```

In this example, note that the layout of this page is being changed every four milliseconds. In this particular system, however, the display will get updated every 16.7 milliseconds on typical 60 Hz monitors. Thus, every four milliseconds javascript on the page will change the width of the black rectangle. Since processing this javascript code is very inexpensive, the change will quickly be noted and control returned to the browser. At this time, the browser will assess what work it has left to do, and—noticing that there is a layout change pending—will start a layout update. The layout subsystem will process the change within the context of the layout rules defined by CSS and HTML, and the results will be available for display.

The results of the first pass through the layout subsystem will, however, be ignored as the monitor is not able to refresh after four milliseconds. The second and third results will similarly be ignored, having occurred at eight and 12 milliseconds respectively. Only the results of the fourth such update will be used to update the display with new, user-visible results as the monitor refreshes after a 16.7 millisecond delay. In this simple example, the wasted work performed by the browser outweighs the useful work by several times.

In accordance with the discussion below, and in the context of the example above, at least one embodiment processes the javascript function as follows. As defined by the javascript, a change will be processed every four milliseconds and a display refresh will be processed every 16.7 milliseconds. Now, however, instead of processing that change immediately insofar as performing a layout change, the browser now stores the value for width used in the previous display update (“0px” in this case) and marks the <div> element, in an associated object model, as having been changed. No layout update, however, is processed at this time. At eight milliseconds, 12 milliseconds, and 16 milliseconds, additional changes are processed, width values are stored, and the <div> element remains marked as having been changed. At 16.7 milliseconds the monitor is once again ready to update, and the browser starts a display refresh.

At this time, recognizing that the <div> element has been marked as changed, the browser delays the display refresh while it performs a layout update using the last-saved value for the width. Having stored the value of the width used in the previous update, the browser is able to efficiently perform an amount of work utilized to update the layout to take into account the changes since the last display refresh. Moreover, having performed a single layout update, the browser avoided wasted work and instead only calculated results that were ultimately displayed to the user. Hence, work associated with a layout update at four, eight, and 12 milliseconds was avoided.

In the following discussion, an example environment is first described that is operable to employ the techniques described herein. Example illustrations of the various embodiments are then described, which may be employed in the example environment, as well as in other environments. Accordingly, the example environment is not limited to performing the described embodiments and the described embodiments are not limited to implementation in the example environment.

Example Environment

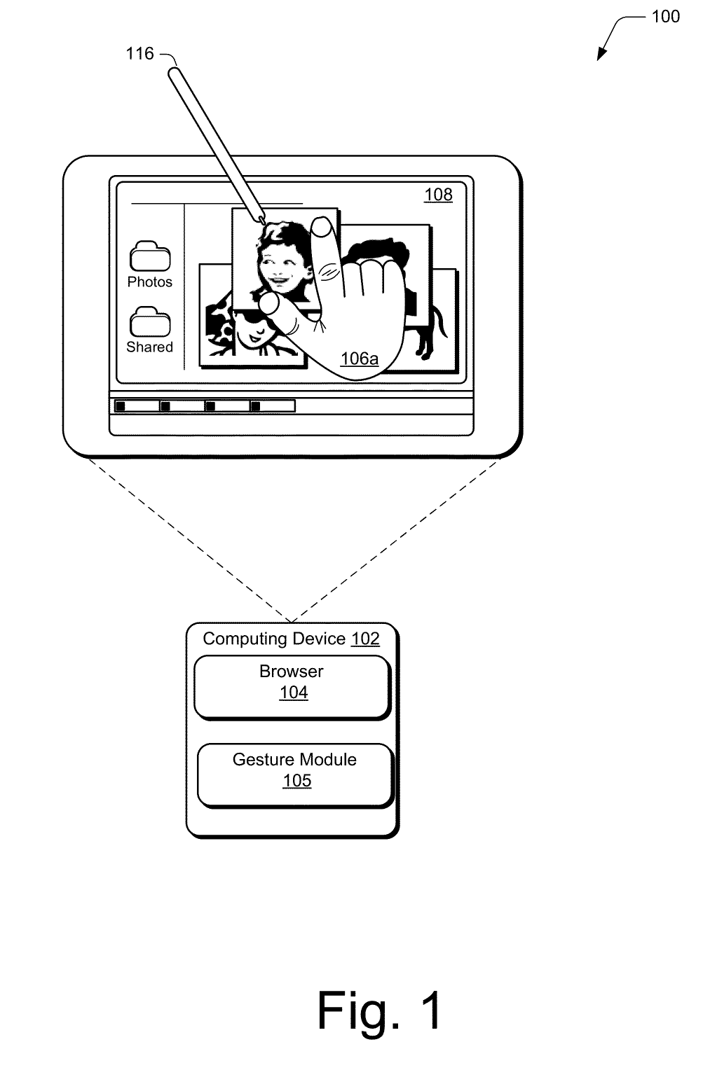

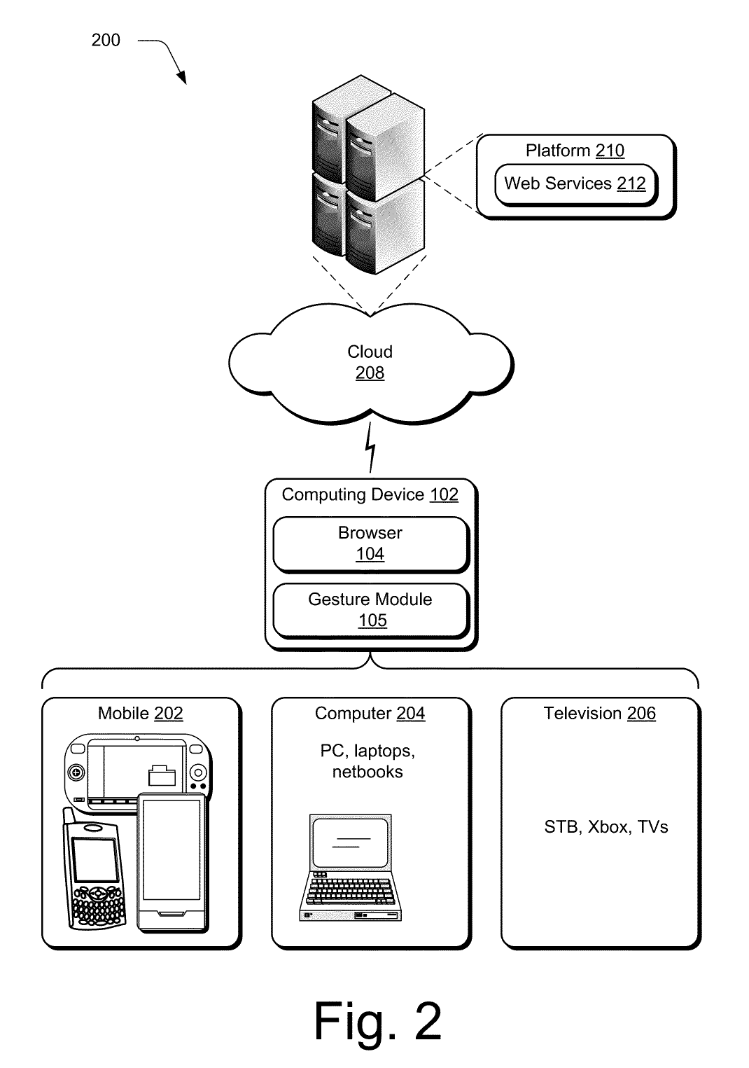

FIG. 1 is an illustration of an environment 100 in an example implementation that is operable to employ the layout and formatting techniques described in this document. The illustrated environment 100 includes an example of a computing device 102 that may be configured in a variety of ways. For example, the computing device 102 may be configured as a traditional computer (e.g., a desktop personal computer, laptop computer, and so on), a mobile station, an entertainment appliance, a set-top box communicatively coupled to a television, a wireless phone, a netbook, a game console, a handheld device, and so forth as further described in relation to FIG. 2. Thus, the computing device 102 may range from full resource devices with substantial memory and processor resources (e.g., personal computers, game consoles) to a low-resource device with limited memory and/or processing resources (e.g., traditional set-top boxes, hand-held game consoles). The computing device 102 also includes software that causes the computing device 102 to perform one or more operations as described below.

Computing device 102 includes a web browser 104 to provide functionality as described in this document. The web browser can be implemented in connection with any suitable type of hardware, software, firmware or combination thereof In at least some embodiments, the web browser is implemented in software that resides on some type of tangible, computer-readable storage medium examples of which are provided below.

Web browser 104 is representative of functionality that enables the user to browse to different websites and consume content associated with those websites. As will be described below in detail, web browser 104 includes a layout pipeline that is configured to batch document formatting and layout operations and to perform layout operations upon notification of a display refresh, as will be described below in more detail below.

Computing device 102 can also include a gesture module 105 that recognizes gestures that can be performed by one or more fingers, and causes operations to be performed that correspond to the gestures. The gestures may be recognized by module 105 in a variety of different ways. For example, the gesture module 105 may be configured to recognize a touch input, such as a finger of a user's hand 106a as proximal to display device 108 of the computing device 102 using touchscreen functionality. Module 105 can be utilized to recognize single-finger gestures and bezel gestures, multiple-finger/same-hand gestures and bezel gestures, and/or multiple-finger/different-hand gestures and bezel gestures.

The computing device 102 may also be configured to detect and differentiate between a touch input (e.g., provided by one or more fingers of the user's hand 106a) and a stylus input (e.g., provided by a stylus 116). The differentiation may be performed in a variety of ways, such as by detecting an amount of the display device 108 that is contacted by the finger of the user's hand 106 versus an amount of the display device 108 that is contacted by the stylus 116.

Thus, the gesture module 105 may support a variety of different gesture techniques through recognition and leverage of a division between stylus and touch inputs, as well as different types of touch inputs.

FIG. 2 illustrates an example system 200 showing the browser 104 and gesture module 105 as being implemented in an environment where multiple devices are interconnected through a central computing device. The central computing device may be local to the multiple devices or may be located remotely from the multiple devices. In one embodiment, the central computing device is a “cloud” server farm, which comprises one or more server computers that are connected to the multiple devices through a network or the Internet or other means.

In one embodiment, this interconnection architecture enables functionality to be delivered across multiple devices to provide a common and seamless experience to the user of the multiple devices. Each of the multiple devices may have different physical requirements and capabilities, and the central computing device uses a platform to enable the delivery of an experience to the device that is both tailored to the device and yet common to all devices. In one embodiment, a “class” of target device is created and experiences are tailored to the generic class of devices. A class of device may be defined by physical features or usage or other common characteristics of the devices. For example, as previously described the computing device 102 may be configured in a variety of different ways, such as for mobile 202, computer 204, and television 206 uses. Each of these configurations has a generally corresponding screen size and thus the computing device 102 may be configured as one of these device classes in this example system 200. For instance, the computing device 102 may assume the mobile 202 class of device which includes mobile telephones, music players, game devices, and so on. The computing device 102 may also assume a computer 204 class of device that includes personal computers, laptop computers, netbooks, and so on. The television 206 configuration includes configurations of device that involve display in a casual environment, e.g., televisions, set-top boxes, game consoles, and so on. Thus, the techniques described herein may be supported by these various configurations of the computing device 102 and are not limited to the specific examples described in the following sections.

Cloud 208 is illustrated as including a platform 210 for web services 212. The platform 210 abstracts underlying functionality of hardware (e.g., servers) and software resources of the cloud 208 and thus may act as a “cloud operating system.” For example, the platform 210 may abstract resources to connect the computing device 102 with other computing devices. The platform 210 may also serve to abstract scaling of resources to provide a corresponding level of scale to encountered demand for the web services 212 that are implemented via the platform 210. A variety of other examples are also contemplated, such as load balancing of servers in a server farm, protection against malicious parties (e.g., spam, viruses, and other malware), and so on.

Thus, the cloud 208 is included as a part of the strategy that pertains to software and hardware resources that are made available to the computing device 102 via the Internet or other networks.

The gesture techniques supported by the gesture module may be detected using touchscreen functionality in the mobile configuration 202, track pad functionality of the computer 204 configuration, detected by a camera as part of support of a natural user interface (NUI) that does not involve contact with a specific input device, and so on. Further, performance of the operations to detect and recognize the inputs to identify a particular gesture may be distributed throughout the system 200, such as by the computing device 102 and/or the web services 212 supported by the platform 210 of the cloud 208.

Generally, any of the functions described herein can be implemented using software, firmware, hardware (e.g., fixed logic circuitry), manual processing, or a combination of these implementations. The terms “module,” “functionality,” and “logic” as used herein generally represent software, firmware, hardware, or a combination thereof. In the case of a software implementation, the module, functionality, or logic represents program code that performs specified tasks when executed on or by a processor (e.g., CPU or CPUs). The program code can be stored in one or more computer readable memory devices. The features of the gesture techniques described below are platform-independent, meaning that the techniques may be implemented on a variety of commercial computing platforms having a variety of processors.

In the discussion that follows, various sections describe example embodiments. A section entitled “Example Web Browser” describes an example Web browser in accordance with one or more embodiments. Next, a section entitled “Example Activity Diagram” describes an example activity diagram in accordance with one or more embodiments. Last, a section entitled “Example Device” describes aspects of an example device that can be utilized to implement one or more embodiments.

Having described example operating environments in which the browser can be utilized, consider now a discussion of an example browser in accordance with one or more embodiments.

Example Web Browser

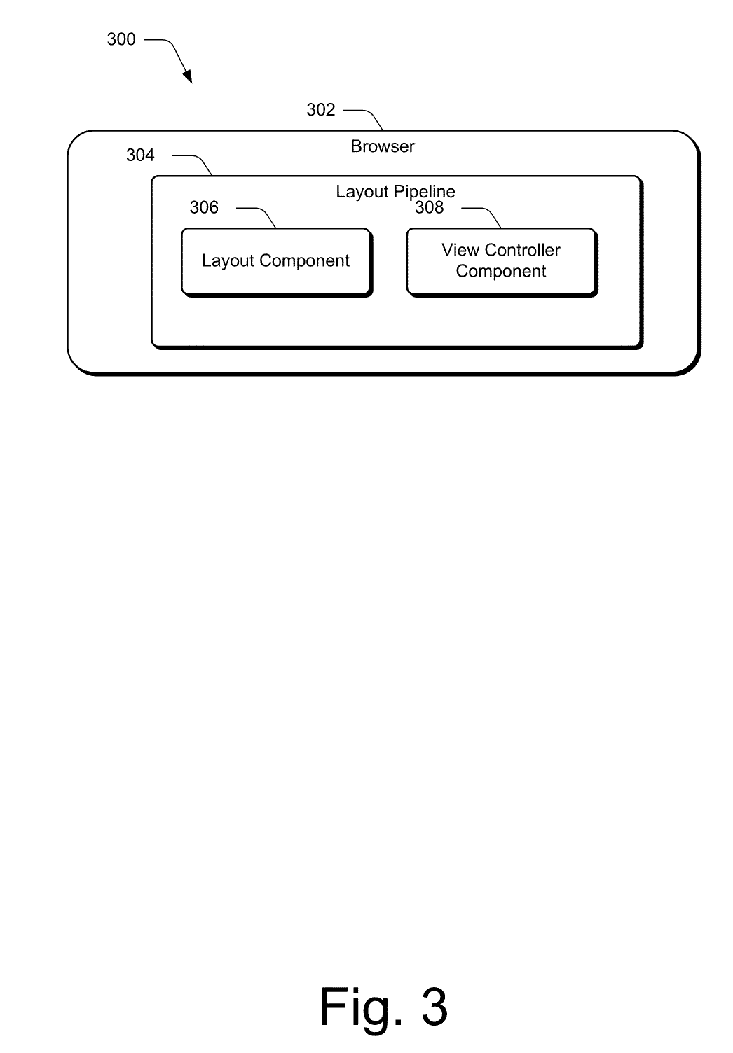

FIG. 3 illustrates system 300 that includes an example web browser 302. Web browser 302 includes a layout pipeline 304 having a plurality of elements or components that work together in order to process a received webpage, layout its particular elements, and enable the laid out elements to be rendered. To this end, the layout pipeline 304 includes, among other elements, a layout component 306 and a view controller component 308.

In operation, when a webpage is received it is typically represented in HTML and can include script, such as JavaScript, that describes various functions that are to be performed in connection with rendering the webpage. The webpage's HTML is processed and an object model is built. The object model represents the various elements defined by the webpage's HTML and other code. Once the object model is built, the view controller component 308 can notify layout component 306 to process the object model sufficient to enable the webpage to be rendered. At this point, the layout component 306 processes object model by iterating over all of the nodes of the object model in performing layout operations. In at least some embodiments, this results in a display tree which can then be provided to a suitably-configured rendering engine. The rendering engine can then process the display tree effective to cause the webpage to be rendered.

In various embodiments in which JavaScript or other code specifies a change to particular element that occurs more frequently than the refresh rate of the applicable system, the layout component 306 can delay layout processing until it receives a notification from the view controller component 308 that a refresh operation is to be performed. Once layout component 306 receives this notification from the view controller component 308, it can then perform its layout processing including iterating over the nodes of the object model and generating, in at least some embodiments, the display tree or other renderable data structure. The display tree or other renderable data structure can then be used by the rendering engine to render the webpage.

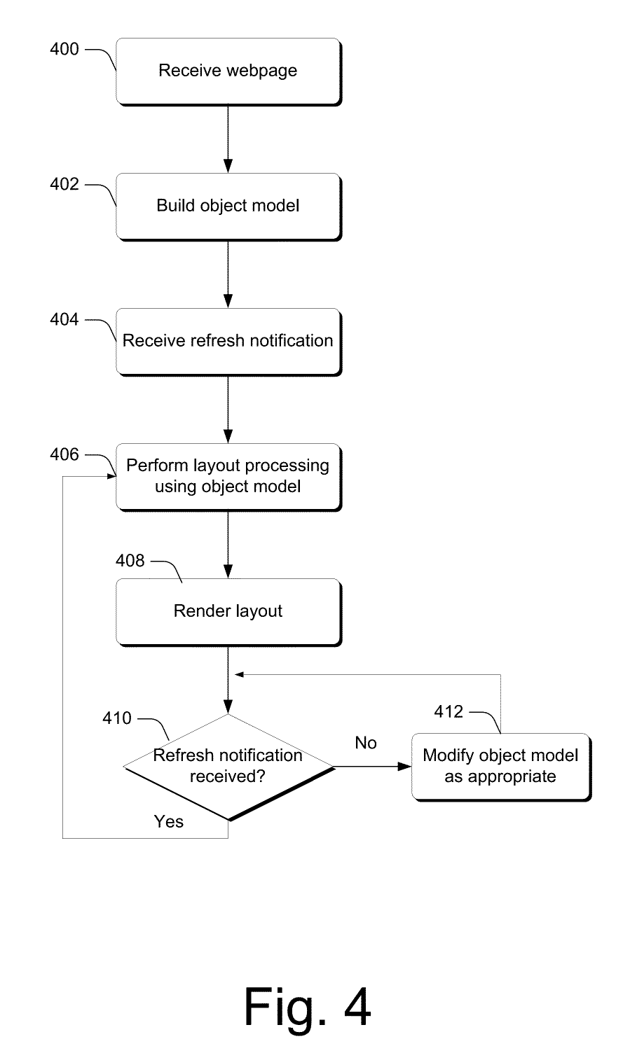

FIG. 4 is a flow diagram that describes steps in a method accordance with one or more embodiments. The method can be performed in connection with any suitable hardware, software, firmware, or combination thereof. In at least some embodiments, the method can be performed by software, e.g., a web browser, embodied on some type of computer-readable storage medium.

Step 400 receives a webpage. Step 402 builds an object model associated with the webpage. Any suitable type of object model can be built. Step 404 receives a refresh notification. Responsive to receiving the refresh notification, step 406 performs layout processing using the object model. Any suitable type of layout processing can be performed. For example, in at least some embodiments, the layout processing iterates over the object model and forms a display tree. A display tree, as noted above, constitutes a data structure that can be utilized by a suitably-configured rendering engine to render the layout. Step 408 renders the layout. Now, subsequent layout processing is not performed until a refresh notification is received. One way to implement this functionality is as follows.

Step 410 ascertains whether a refresh notification has been received. If no refresh notification has been received, step 412 modifies the object model as appropriate and returns to step 410. If, on the other hand, a refresh notification has been received, the method returns to step 406 and performs layout processing using the object model which may or may not have been modified at step 412.

Accordingly, this constitutes a departure from a “layout-driven” approach in which layout processing is performed without regard to an appreciation of the refresh frequency of the particular system of which the browser comprises a part. Rather, a more tightly integrated coupling between a system's refresh rate and its layout processing serves to reduce layout work inefficiencies by ensuring that layout processing is performed when a refresh operation is to be performed. Accordingly, when a refresh operation is not to be performed, layout processing does not take place. Rather, an associated object model is updated to reflect any defined changes that are to occur in between refresh operations. The modified object model then undergoes layout processing when notification of a refresh operation is received.

Example Activity Diagram

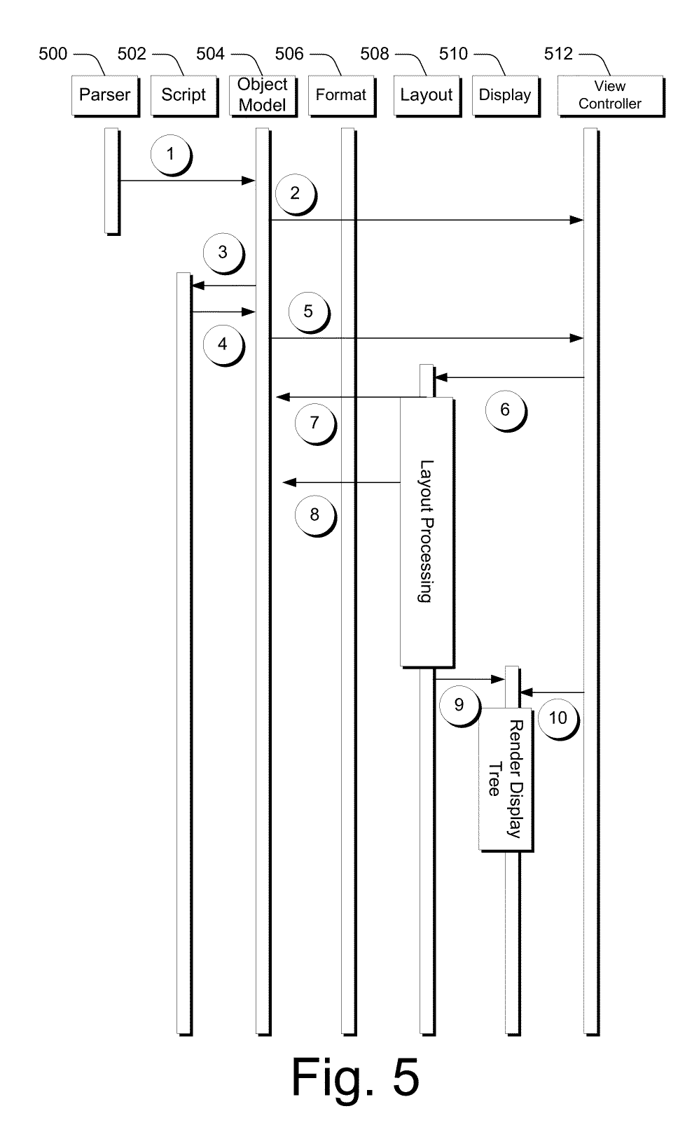

FIG. 5 illustrates a simplified example activity diagram that includes multiple different components in a layout pipeline in accordance with one or more embodiments. In this particular example, components within the layout pipeline include a parser 500, a script component 502, an object model 504, a format component 506, a layout component 508, a display component 510, and a view controller component 512. Calls that are made between the various components are represented, generally, by encircled numbers. The calls, in this embodiment, occur in the order in which they appear numerically. For the sake of brevity, some of the calls and callbacks that are made between the various illustrative components are omitted. The description that follows utilizes the HTML example described above.

In the illustrated and described embodiment, parser 500 is configured to receive and parse HTML content associated with a webpage. The parser processes the HTML which includes a number of HTML elements and, from the HTML elements builds a Document Object Model (DOM), herein referred to as simply an “object model.”

Script component 502 is configured to interpret scripting source code and execute the script accordingly. In the illustrated and described embodiment, script component 502 comprises a JavaScript component.

Object model 504, in the illustrated and described embodiment, is a platform- and language-neutral interface that allows programs and scripts to dynamically access and update content, structure, and the style of associated documents, such as web pages. The documents can be further processed and the results of that processing can be incorporated back into a presented page.

Format component 506 is configured as a format cache to hold specified values which have a visual impact in preparation for the layout operations. For example, the format component 506 can hold HTML and CSS values that affect visual aspects of the layout operations.

Layout component 508 is configured to iterate over all the nodes of the object model and create a display tree. Creation of the display tree takes place through what is referred to in this document as “layout processing.” Layout processing can be resource intensive, as noted above. Layout processing includes processing information from the object model, such as HTML, XML, image files and the like, as well as formatting information such as CSS, XSL, and the like, and ascertaining where and how these elements are to be rendered on a computing device's display.

Display component 510 is configured to process the display tree and display or render the formatted content onto a computing device's display.

View controller component 512 is configured to cause the display component to refresh the screen by rendering the display tree. This is done, in part, by issuing a refresh notification or call to the layout component 508, as described below.

In operation, content including HTML and CSS content are received by the web browser and parsed by parser 500. Through a series of calls from the parser 500 to the object model component 504, illustrated at “1”, the object model is created. When the object model is created, the view controller 512 is notified, illustrated at “2”, that the object model's content is to be used to render content at some point in the future.

When the parser completes its operations, an event is fired (not shown) to indicate that the status of the object model is complete. The object model 504 calls the script engine 502, illustrated at “3”, to start the script engine. The script engine then sets a timer by calling the object model 504, illustrated at “4”. The object model then calls the view controller 512, as illustrated at “5”, to set the timer. In these calls, the script engine is essentially indicating that it wishes to be notified at a particular time so that it can perform work that it wishes to perform.

The view controller then calls the layout component 508, as illustrated at “6” to indicate that content is ready for rendering. At this point, layout processing can occur. When layout processing starts, the layout component 508 calls the object model, as illustrated at “7” so that the object model can recompute the various formatting information for the HTML and CSS for use in layout processing. The layout component 508 then calls the object model, as illustrated at “8” to retrieve the computed formatting information for use in its layout operations.

At this point, the layout component 508 iterates over all of the nodes of the object model and updates the layout, thus building a display tree. The layout component 508 then calls the display component 510, as illustrated at “9” to inform the display component that the display tree has been completed and is ready for rendering. Now, the system waits until the display component receives a call, as illustrated at “10”, from the view controller 512 indicating that it is to render the display tree. The display component 510 can now render the display tree to screen.

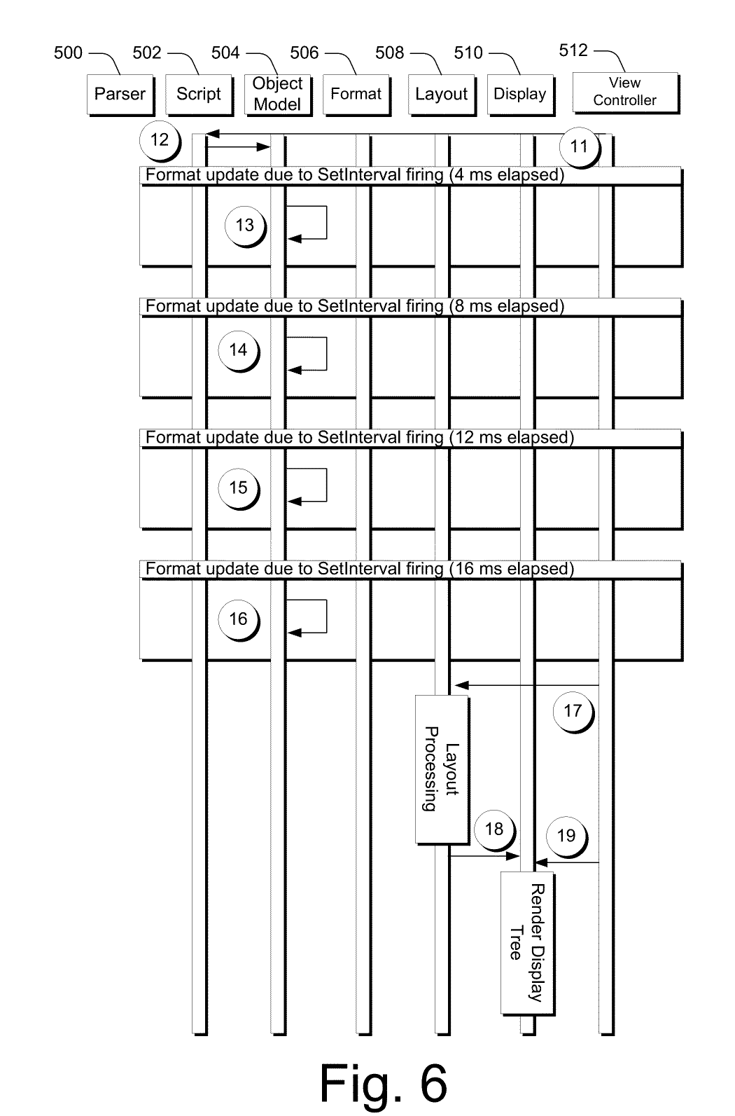

Continuing with this example, and referring to FIG. 6, the process of allowing the view controller 512 to notify the layout component 512 that layout processing should occur is repeated. Specifically, in the illustrated and described embodiment, the view controller 512 calls back the script component 502, as illustrated at “11”, to notify the script component of the expiration of a particular time interval. The script component 502 sets another timer, as illustrated at “12”, similar to the call that was made at “4” above. Now the script component performs some work and the object model is updated at “13”. Callbacks (not shown) from the view controller 512 are received at the end of the relevant time intervals specified by the script component, and the object model is updated at “14”, “15”, and “16” respectively.

The view controller 512 calls the layout component 508, as illustrated at “17”, to notify the layout component that layout processing is to occur. Upon completion of the layout processing, the layout component 508 calls the display component 510, as illustrated at “18”, to notify the display component that the display tree is completed. The system then waits until the next refresh notification, which occurs in a call from the view controller 512 to display component 510, as illustrated at “19”.

This process can then repeat itself and continue until processing is complete. Utilizing the techniques described herein, the object model can be updated to reflect work performed by the script component 502, without necessarily causing layout processing to be performed. Rather, layout processing is tied or coupled more closely to display refreshes. Thus, the layout processing work which can be more resource intensive is deferred until such time that refresh is to occur. As such, processing economies are gained and resources are more efficiently utilized.

Having described various embodiments in which layout processing is more closely tied to a system's display refresh functionality, consider now an example device that can be utilized to implement one or more embodiments.

Example Device

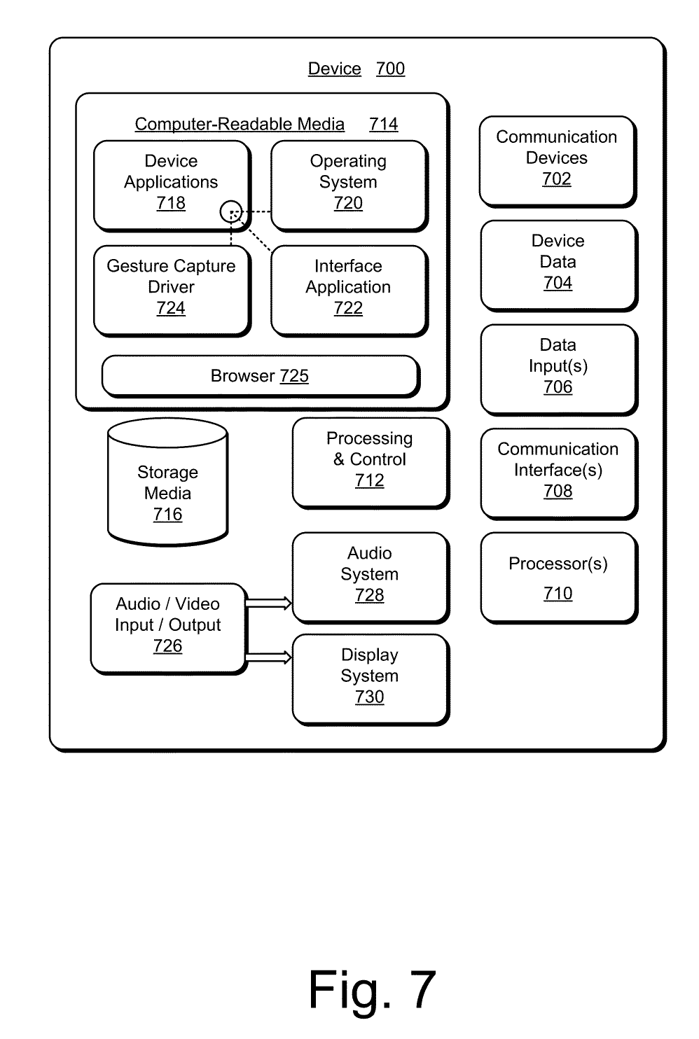

FIG. 7 illustrates various components of an example device 700 that can be implemented as any type of portable and/or computer device as described with reference to FIGS. 1 and 2 to implement the embodiments described herein. Device 700 includes communication devices 702 that enable wired and/or wireless communication of device data 704 (e.g., received data, data that is being received, data scheduled for broadcast, data packets of the data, etc.). The device data 704 or other device content can include configuration settings of the device, media content stored on the device, and/or information associated with a user of the device. Media content stored on device 700 can include any type of audio, video, and/or image data. Device 700 includes one or more data inputs 906 via which any type of data, media content, and/or inputs can be received, such as user-selectable inputs, messages, music, television media content, recorded video content, and any other type of audio, video, and/or image data received from any content and/or data source.

Device 700 also includes communication interfaces 708 that can be implemented as any one or more of a serial and/or parallel interface, a wireless interface, any type of network interface, a modem, and as any other type of communication interface. The communication interfaces 708 provide a connection and/or communication links between device 700 and a communication network by which other electronic, computing, and communication devices communicate data with device 700.

Device 700 includes one or more processors 710 (e.g., any of microprocessors, controllers, and the like) which process various computer-executable or readable instructions to control the operation of device 700 and to implement the embodiments described above. Alternatively or in addition, device 700 can be implemented with any one or combination of hardware, firmware, or fixed logic circuitry that is implemented in connection with processing and control circuits which are generally identified at 712. Although not shown, device 700 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 700 also includes computer-readable media 714, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 700 can also include a mass storage media device 716.

Computer-readable media 714 provides data storage mechanisms to store the device data 704, as well as various device applications 718 and any other types of information and/or data related to operational aspects of device 700. For example, an operating system 720 can be maintained as a computer application with the computer-readable media 714 and executed on processors 710. The device applications 718 can include a device manager (e.g., a control application, software application, signal processing and control module, code that is native to a particular device, a hardware abstraction layer for a particular device, etc.), as well as other applications that can include, web browsers, image processing applications, communication applications such as instant messaging applications, word processing applications and a variety of other different applications. The device applications 718 also include any system components or modules to implement embodiments of the techniques described herein. In this example, the device applications 718 include an interface application 722 and a gesture-capture driver 724 that are shown as software modules and/or computer applications. The gesture-capture driver 724 is representative of software that is used to provide an interface with a device configured to capture a gesture, such as a touchscreen, track pad, camera, and so on. Alternatively or in addition, the interface application 722 and the gesture-capture driver 724 can be implemented as hardware, software, firmware, or any combination thereof. In addition, computer readable media 714 can include a web browser 725 that functions as described above.

Device 700 also includes an audio and/or video input-output system 726 that provides audio data to an audio system 728 and/or provides video data to a display system 730. The audio system 728 and/or the display system 730 can include any devices that process, display, and/or otherwise render audio, video, and image data. Video signals and audio signals can be communicated from device 700 to an audio device and/or to a display device via an RF (radio frequency) link, S-video link, composite video link, component video link, DVI (digital video interface), analog audio connection, or other similar communication link. In an embodiment, the audio system 728 and/or the display system 730 are implemented as external components to device 700. Alternatively, the audio system 728 and/or the display system 730 are implemented as integrated components of example device 700.

Conclusion

In the embodiments described above, processing efficiencies are gained within the web browser by utilizing the display refresh notifications to drive layout processing within a web browser's layout pipeline. By doing so, the browser can ensure that layout computation is performed when the computed layout is actually to be displayed by the computing device. This can enable the web browser to defer and batch numerous changes into a single layout update, thereby reducing overall CPU utilization while maintaining user responsiveness.

Although the embodiments have been described in language specific to structural features and/or methodological acts, it is to be understood that the embodiments defined in the appended claims are not necessarily limited to the specific features or acts described. Rather, the specific features and acts are disclosed as example forms of implementing the claimed embodiments.

What is claimed is:

1. One or more computer readable storage media embodying computer readable instructions which, when executed, implement a web browser comprising:
a layout pipeline comprising:
a view controller component configured to cause a refresh operation to be performed; and
a layout component configured to perform layout processing sufficient to enable a webpage to be rendered, the layout component being configured to delay layout processing until a refresh notification is received from the view controller component.

2. The one or more computer readable storage media of claim 1, wherein the layout component is configured to perform layout processing by building a display tree that can be rendered by a display component.

3. The one or more computer readable storage media of claim 1, wherein the layout component is configured to iterate over nodes of an associated object model to create a renderable display tree, responsive to receiving the refresh notification from the view controller component.

4. The one or more computer readable storage media of claim 1 further comprising an object model that is configured to be processed to provide renderable content, wherein the object model is configured to be updated without causing layout processing to be performed by the layout component.

5. The one or more computer readable storage media of claim 1 further comprising an object model that is configured to be processed to provide renderable content, wherein the object model is configured to be updated without causing layout processing to be performed by the layout component, the layout component being configured to perform layout processing associated with an updated object model responsive to receiving a subsequent refresh notification from the view controller component.

6. The one or more computer readable storage media of claim 1 further comprising an object model that is configured to be processed to provide renderable content, wherein the object model is configured to be updated multiple times without causing layout processing to be performed by the layout component.

7. The one or more computer readable storage media of claim 1 further comprising an object model that is configured to be processed to provide renderable content, wherein the object model is configured to be updated multiple times without causing layout processing to be performed by the layout component, the layout component being configured to perform layout processing associated with an updated object model responsive to receiving a subsequent refresh notification from the view controller component.

8. A computer-implemented method comprising;
receiving a webpage;
building an object model associated with the webpage;
receiving a refresh notification;
responsive to receiving the refresh notification, performing layout processing using the object model to produce a renderable layout;
rendering the layout; and
not performing subsequent layout processing until another refresh notification is received.

9. The method of claim 8, wherein said performing layout processing comprises iterating over the object model and forming a display tree.

10. The method of claim 8, wherein said not performing subsequent layout processing comprises:
ascertaining whether a refresh notification has been received; responsive to not receiving a refresh notification, modifying the object model as appropriate; and
further comprising:
responsive to receiving a refresh notification, performing layout processing using either the first-mentioned object model or a modified object model.

11. The method of claim 8 further comprising updating the object model without causing layout processing to occur.

12. The method of claim 8 further comprising updating the object model multiple times without causing layout processing to occur.

13. A computing device comprising:
one or more processors;
one or more computer readable media;
a web browser embodied on the one or more computer readable media and executable under the influence of the one or more processors, the web browser being configured to utilize display refresh notifications to drive layout processing within a layout pipeline of the web browser.

14. The computing device of claim 13, wherein the layout pipeline comprises a view controller component configured to cause a refresh operation to be performed and a layout component configured to receive a call from the view controller component that causes layout processing to be performed by the layout component.

15. The computing device of claim 13, wherein the layout pipeline comprises a view controller component configured to cause a refresh operation to be performed and a layout component configured to receive a call from the view controller component that causes layout processing to be performed by the layout component, the layout component being configured to perform layout processing by building a display tree that can be rendered by a display component.

16. The computing device of claim 13, wherein the layout pipeline comprises a view controller component configured to cause a refresh operation to be performed and a layout component configured to receive a call from the view controller component that causes layout processing to be performed by the layout component, the layout component being configured to perform layout processing by iterating over nodes of an associated object model to create a renderable display tree.

17. The computing device of claim 13, wherein the layout pipeline comprises an object model that is configured to be updated without causing layout processing to be performed.

18. The computing device of claim 13, wherein the layout pipeline comprises an object model that is configured to be updated multiple times without causing layout processing to be performed.

19. The computing device of claim 13, wherein the layout pipeline is configured to process multiple script-based changes without causing layout processing to be performed.

20. The computing device of claim 13, wherein the layout pipeline is configured to batch multiple changes that occur at different times between refreshes into a single layout update.
